(19) United States
(12) Patent Application Publication
(10) Pub. No.: US 2007/0227375 A1
(43) Pub. Date: Oct. 4, 2007

(54) Anilox printing unit

(75) Inventors: Michael Donath, Leimen (DE); Udo Greulich, Rauenberg (DE); Dieter Huber, Sinsheim (DE); Jurgen Michels, Dossenheim (DE); Dieter Schaffrath, Lorsch (DE); Wolfgang Schonberger, Schriesheim (DE); Bernhard Schwaab, Neustadt (DE); Michael Thielemann, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/729,391

(22) Filed: Mar. 28, 2007

(30) Foreign Application Priority Data
Mar. 28, 2006 (DE) 10 2006 014 672.7

(51) Int. Cl. B41F 9/00

(52) U.S. Cl. 101/153

(57) ABSTRACT

An anilox printing unit contains an engraved roller, an ink applicator roller, a first cylinder and a second cylinder as elements. At least one of the elements is a cambered or quasi-cambered element. The ink applicator roller is preferably the element. Such a configuration of the element ensures a high quality inking process.

### CROSS-REFERENCE TO RELATED APPLICATION

This application claims the priority, under 35 U.S.C. §119, of German application DE 10 2006 014 672.7, filed Mar. 28, 2006; the prior application is herewith incorporated by reference in its entirely.

### BACKGROUND OF THE INVENTION

### Field of the Invention

The invention relates to an anilox printing unit which contains an engraved roller, an ink applicator roller, a first cylinder and a second cylinder as elements.

Published, non-prosecuted German patent DE 199 47 223 A1 describes an anilox printing unit which contains an engraved roller, an ink applicator roller and a printing form cylinder. The printing form cylinder is equipped with bearer rings which are operatively connected to bearer rings of the ink applicator roller. This configuration is intended to achieve a situation where reaction forces which come from the printing form cylinder cannot have an effect on the quality of the inking. However, it has been shown in tests that this measure is not sufficient, in order to achieve sufficient quality of the inking.

German patent DE 102 57 746 B3, corresponding to U.S. Pat. No. 6,860,200, describes a form cylinder which is cambered. Accordingly, the diameter of the form cylinder is at its greatest in its longitudinal center and at its smallest at the end sides. Although the line force differences between the printed edge and the printed center can be reduced considerably by this, this measure which relates to the form cylinder, requires a complicated configuration of the printing plate which is clamped onto the form cylinder.

European patent EP 0 729 832 B1, corresponding to U.S. Pat. No. 5,680,815, discloses a dampening solution applicator roller which has roller ends which are beveled.

### SUMMARY OF THE INVENTION

It is accordingly an object of the invention to provide an anilox printing unit that overcomes the above-mentioned disadvantages of the prior art devices of this general type, which ensures high quality inking.

With the foregoing and other objects in view there is provided, in accordance with the invention, an anilox printing unit. The anilox printing unit has elements including an engraved roller, an ink applicator roller, a first cylinder, and a second cylinder. At least one of the elements is a cambered element or a quasi-cambered element.

This measure achieves uniform ink management and ink density transversely with respect to the printing direction. This is ensured, without corrections by the operator being required. As the anilox printing unit contains a zoneless inking unit, corrections of this kind by the operator would only be possible anyway in a limited manner. The cambered or quasi-cambered shape of the at least one element compensates the ink transport in the printed center onto the printing material which is preferably a printing material sheet. Without the measure according to the invention, the ink transport in the printed center would be reduced with respect to the printed edges.

In one development, the cambered or quasi-cambered element is thicker by from 0.05 millimeter to 0.30 millimeter at its axial center than at its axial ends. It goes without saying that the axial ends are not meant as the bearing journals of the cylinder or of the roller, but the ends of the cylinder barrel or roller barrel.

In a further development, the quasi-cambered element has conical ends which bring about its quasi-cambered shape. The quasi-cambered element has an axial overall length and the conical ends in each case has an axial sectional length which is at least 10% of the axial overall length and at most 30% of the axial overall length. It goes without saying that the conical ends are not located on the bearing journals of the cylinder or the roller, but on the cylinder barrel or roller barrel.

In a further development, the cambered or quasi-cambered element forms a convex press strip together with one of the elements under operating load. The cambered or quasi-cambered element and/or the element, with which the cambered or quasi-cambered element together forms the convex press strip, have/has an elastomeric circumferential surface. The circumferential surface is deformed under the effect of the contact pressure in the cylinder or roller nip which is formed by the two elements together. The resultant flattening of the elastomer circumferential surface is the convex press strip which extends longitudinally in parallel with the rotational axes of the two elements. The width of the press strip decreases constantly from the center of its longitudinal extent to the ends of the press strip, with the result that the press strip is convex.

In a further development, the cambered or quasi-cambered element forms a further convex press strip together with a further one of the elements under operating load.

It could be assumed that it would be advantageous with regard to the quality of the ink transfer to aim for press strips, the width of which is constant as viewed over the length of the press strip, that is to say press strips which are neither concave nor convex. However, it has been shown surprisingly in tests that the best ink transfer is achieved by a convex shape of the press strip or of the press strips. In order to achieve the convex press strip shape, the convex or quasi-convex generatrix profile of the cambered or quasi-cambered element is dimensioned accordingly with consideration of further parameters, such as the forces which act.

According to a further development, the cambered or quasi-cambered element is the only one. Accordingly, each of the other three abovementioned elements has an external diameter which is constant over its axial length. It is particularly advantageous if the printing form cylinder, which belongs to three of the elements, of the anilox printing unit does not have a cambered or quasi-cambered shape, with the result that standard printing plates can be used for clamping onto the printing form cylinder.

In a further development, the cambered or quasi-cambered element is the ink applicator roller. Here, the ink applicator roller can form one convex press strip together with the adjacent engraved roller and the other convex press strip together with the adjacent printing form cylinder.

In a further development, the ink applicator roller has a basic body and a rubber blanket which is clamped onto it. Here, the basic body can have a cylinder channel, in which a clamping device is arranged for clamping the rubber blanket.

There are different variants for structurally realizing the cambered or quasi-cambered shape of the ink applicator roller.

According to one variant, the basic body is cambered or quasi-cambered. The advantage of this variant lies in the fact that the rubber blanket can be a standard rubber blanket with a uniform thickness.

According to a further variant, the rubber blanket is cambered or quasi-cambered, that is to say the thickness of the rubber blanket increases from the two side edges of the rubber blanket toward its center.

According to a further variant, a cambered or quasi-cambered underlay is disposed between the basic body and the rubber blanket. In relation to the printed width, the thickness of the underlay decreases from the center toward the side edges. It is also the case in this variant that a rubber blanket can advantageously be used with a thickness which is constant over the printed width.

In one development which is advantageous with regard to the configuration of the anilox printing unit as an offset printing unit, the above-mentioned first cylinder is a printing form cylinder and the above-mentioned second cylinder is a transfer or blanket cylinder.

Also part of the invention is a printing press which is equipped with at least one anilox printing unit which is configured according to the invention or in accordance with one of the developments. The printing press is preferably a sheet-fed printing press.

Other features which are considered as characteristic for the invention are set forth in the appended claims.

Although the invention is illustrated and described herein as embodied in an anilox printing unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side view of a printing press having an anilox printing unit according to the invention;

FIGS. 2A-2D are diagrammatic, sectional views of different exemplary embodiments of a cambered or quasi-cambered ink applicator roller of the anilox inking unit shown in FIG. 1; and

FIG. 3 is a diagrammatic illustration of different press strips of the anilox inking unit shown in FIG. 1.

### DESCRIPTION OF THE PREFERRED EMBODIMENTS

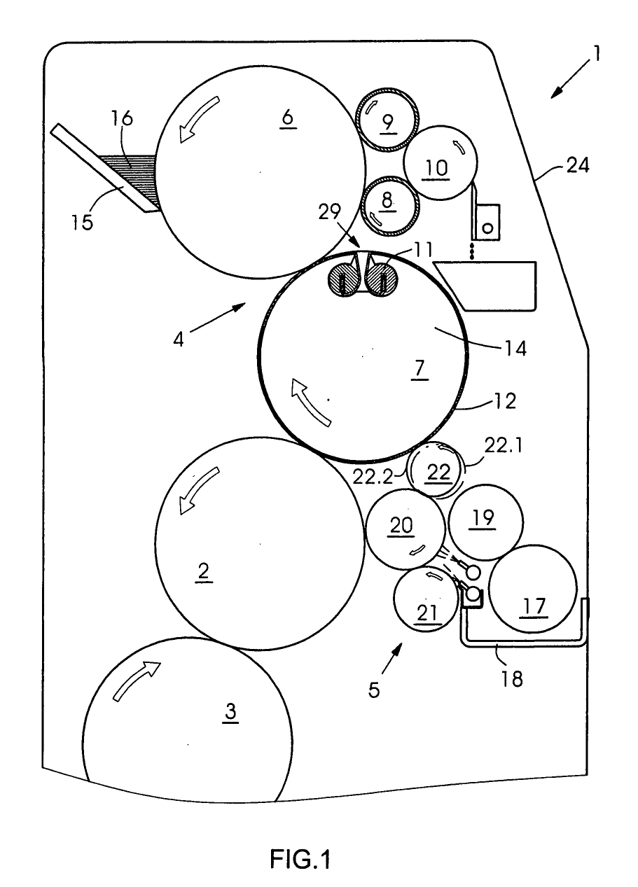

Referring now to the figures of the drawing in detail and first, particularly, to FIG. 1 thereof, there is shown a printing press 1 for offset printing and contains an anilox printing unit 24 having a printing form cylinder 2, a blanket cylinder 3, an anilox inking unit 4 and a dampening unit 5. The anilox inking unit 4 contains an engraved roller 6 and an ink applicator roller 7 which have the same diameter as the printing form cylinder 2. Moreover, the anilox inking unit 4 contains a first roller 8, a second roller 9 and a third roller 10. The first roller 8 and the second roller 9 bear against the engraved roller 6, and the third roller 10 bears against the first roller 8 and against the second roller 9. The ink applicator roller 7 has a clamping device 11 for clamping a rubber blanket 12, which clamping device 11 is seated in a cylinder channel 29 of the ink applicator roller 7. The cylinder channel 29 is incorporated into a basic body 14 of the ink applicator roller 7. Furthermore, the anilox inking unit 4 contains an ink doctor 15 which bears against the engraved roller 6 and holds a printing ink supply 16. The dampening unit 5 includes a dip roller 17 in a dampening solution fountain 18, a metering roller 19, a dampening solution applicator roller 20 and a dampening solution distributor roller 21 which oscillates axially. As a transfer roller, the metering roller 19 bears against the dip roller 17 and at the same time against the dampening solution applicator roller 20 if the printing press 1 is running in the printing operation mode (not shown in the drawing). A bridging roller 22 is mounted such that it can be displaced optionally into a first position 22.1 and into a second position 22.2.

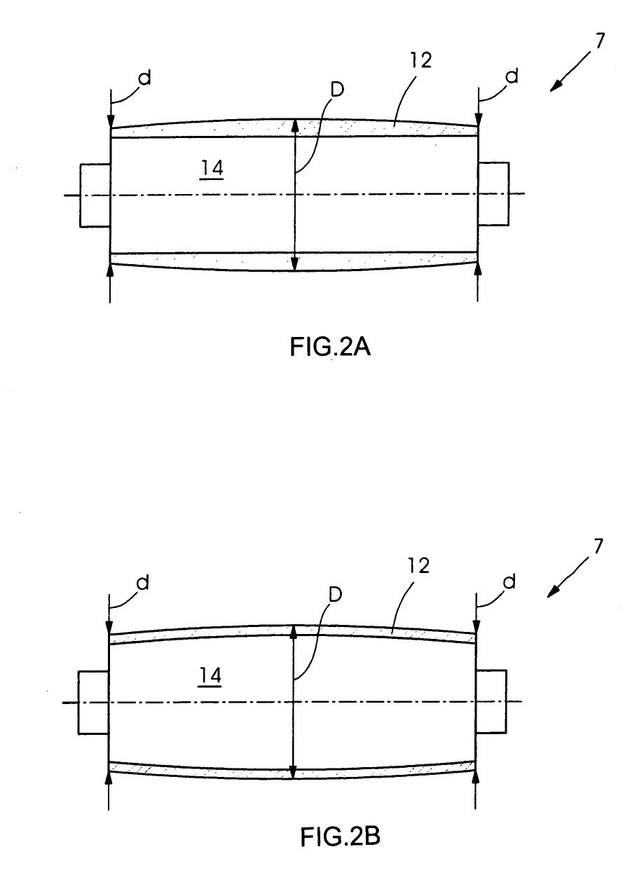

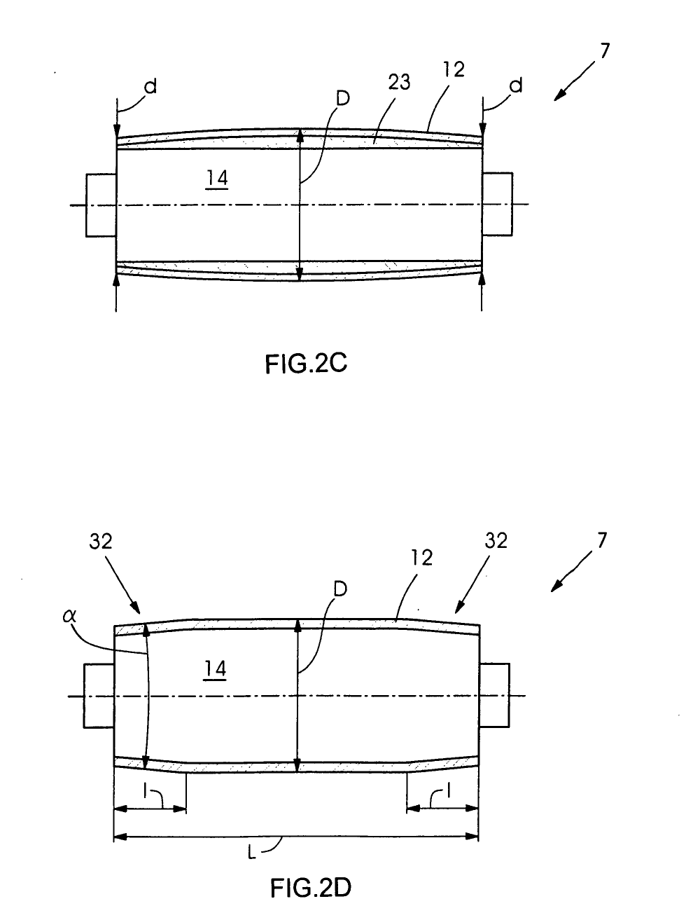

FIG. 2A shows that the barrel shape or cambered shape of the ink applicator roller 7 according to a first variant can be achieved by the thickness of the rubber blanket 12 which is clamped onto the ink applicator roller 7 increasing constantly from its side edges to the center. In relation to the profile of the rubber blanket 12 which can be seen in FIG. 2A, the inner contour line extends linearly and the outer contour line extends convexly, for example in an arcuate or parabolic shape. This makes an ideally cylindrical configuration of the basic body 14 possible, which is advantageous in terms of manufacturing technology, that is to say the external diameter of the basic body 14 does not change over its length. The difference between a greater external diameter D of the ink applicator roller 7 which is to be measured in the axial center and a smaller external diameter d of the ink applicator roller 7 which is to be measured at the respective side edge is therefore brought about solely by the corresponding profiling of the rubber blanket 12. This variant is therefore particularly suitable for retrofitting of printing presses which have an ink applicator roller with a usually ideally cylindrical basic body.

FIG. 2B shows a second variant for achieving the cambered shape, the basic body 14 itself being cambered or barrel-shaped in contrast to the first variant shown in FIG. 2A. Here, the basic body 14 can have the shape of a circular arc or parabola. This is advantageous with regard to the manufacturing of the rubber blanket 12 which can be of constant thickness here, in relation to the format or printed width. It can be seen in FIG. 2B that an outer and an inner contour line of the profile of the rubber blanket 12 extends equidistantly and in parallel with one another over the printed width. Accordingly, only the barrel shape of the basic body 14 brings about a situation where the central external diameter D is greater than the lateral external diameters d. One advantage of this variant is to be seen in the fact that the rubber blanket 12 can be an inexpensive commercially available rubber blanket.

FIG. 2C shows a third variant, in which the cambered shape is brought about by an underlay 23 which is inserted between the basic body 14 and the rubber blanket 12. As can be seen in FIG. 2c, the underlay 23 has a profile which corresponds in principle to the above-described profile of the rubber blanket in FIG. 2A. Moreover, it can be seen in FIG. 2C that the rubber blanket 12 has a profile which corresponds substantially to the profile of the rubber blanket in FIG. 2B. As both the basic body 14 and the rubber blanket 12 are non-cambered and only the underlay 23 is cambered, as it were, it is also only the latter that brings about a situation where the proximal external diameter D of the ink applicator roller 7 is greater than the distal external diameters d by a defined amount. This amount can lie in the range from 0.05 millimeter to 0.30 millimeter if the printed width is approximately 500 millimeters, this difference in diameter also relating to the variants which are shown in FIGS. 2A and 2B. The variant which is shown in FIG. 2C is also well suited for retrofitting purposes. A further advantage of the variants in FIGS. 2A and 2C is to be seen in the possibility which they afford for varying the cambered shape. In order to increase or to reduce the cambered shape, the rubber blanket 12 or the underlay 23 only have to be exchanged for a rubber blanket or an underlay with a thickness profile which is accordingly more or less convex.

FIG. 2D shows a fourth variant, in which the quasi-cambered shape is brought about by conical ends 32. The conical ends 32 are those of the basic body 14, with the result that the rubber blanket 12 can be of constant thickness. The basic body 14 has an overall length L which is to be measured in the direction of the rotational axis of the ink applicator roller 7 and can also be denoted as a roller barrel length. Axle journals of the ink applicator roller 7 are situated outside this overall length L. Each conical end 32 has an axial section length l which is between 10% and 30% of the overall length L. The axial section lengths l are preferably in each case approximately 20% of the overall length L. The cone angle α of the conical ends 32 is at least 0.04° and at most 0.20°, and preferably 0.06°.

It goes without saying that combinations of the variants which are shown in FIGS. 2A to 2C with one another are also possible.

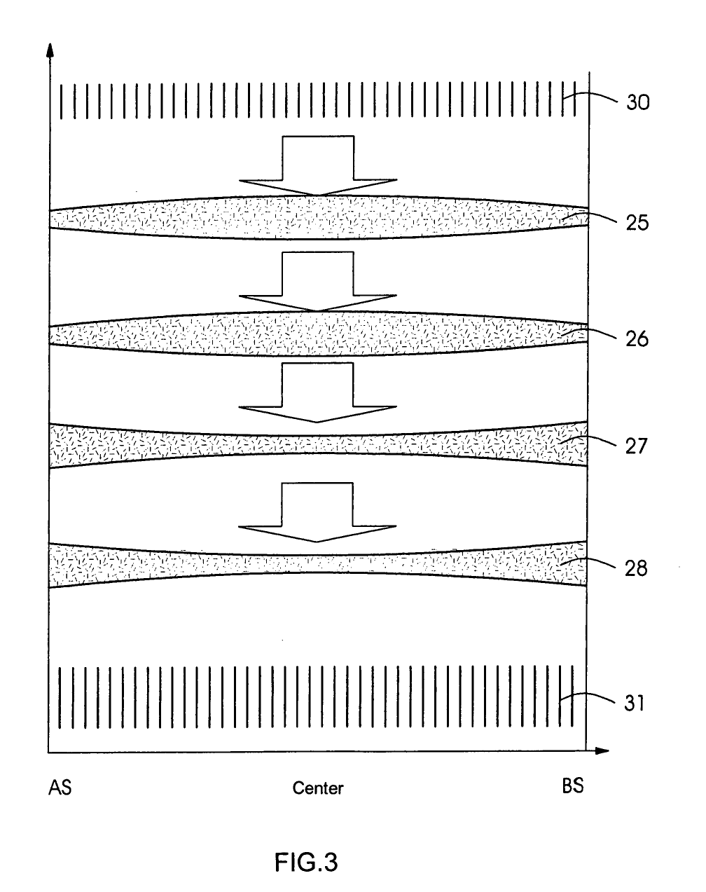

FIG. 3 is a diagram which shows the effects of the roller cambered shape which is configured according to FIGS. 2A to 2C. In this context, the cambered shape also refers to the quasi-cambered shape. The engraved roller 6 provides an ink supply 30 which is constant over the overall format or printed width, as is shown diagrammatically in FIG. 3. The designation 25 denotes a press strip which is formed by the cambered ink applicator roller 7 together with the engraved roller 6. The ink applicator roller 7 forms a further press strip 26 with the printing form cylinder 2, when the ink applicator roller 7 is thrown onto the latter. The engraved roller 6 and the printing form cylinder 2 are pressed into the soft circumferential surface of the ink applicator roller 7, which soft circumferential surface is formed by the rubber blanket 12, with the result that reversible impressions in the form of the press strips 25, 26 are produced in the circumferential surface.

Without the roller cambered shape, the press strips 25, 26 would be concave or constricted, that is to say at their widest on the drive side AS and the operating side BS of the printing press 1 and at their narrowest in the center of the strip length. If the camber of the roller were excessively small, the press strips 25, 26 would be of constant width, that is to say rectangular, over the entire length. In both cases, that of constriction and constancy of width, an ink density which can be measured in the printed image would decrease from the drive side AS and the operating side BS toward the center of the printed width in an undesired manner.

This negative effect does not occur in the cambered shape according to the invention. It can be seen in FIG. 3 that the press strips 25, 26 taper from the center toward the strip ends, and that an ink density 31 extends constantly over the overall printed width as a consequence. This is achieved by a sufficient degree of camber, that is to say by a correspondingly large difference between the edge-side smaller external diameter d and the central greater external diameter D, and by the corresponding cone angle α. The required magnitude of this difference in diameter or of the cone angle α can be different from application to application and depends on many factors, such as the forces which act on the ink applicator roller 7, the format width and the material of the rubber blanket 12.

Furthermore, FIG. 3 shows that a press strip 27 which is formed by the printing form cylinder 2 together with the blanket cylinder 3 and a press strip 28 which is formed in the press nip can admittedly extend in a concave or constricted manner, without this impairing the advantageous effect of the cambered shape of the ink applicator roller 7 substantially. The blanket cylinder 3 forms the above-mentioned press nip together with an impression cylinder (not shown in the drawing) which transports the sheet-shaped printing material.

We claim:

1. An anilox printing unit, comprising:
elements including an engraved roller, an ink applicator roller, a first cylinder, and a second cylinder, at least one of said elements selected from the group consisting of a cambered element and a quasi-cambered element.

2. The anilox printing unit according to claim 1, wherein said cambered element and said quasi-cambered element each have an axial center and axial ends, said cambered element and said quasi-cambered element are thicker by from 0.05 millimeter to 0.30 millimeter at said axial center than at said axial ends.

3. The anilox printing unit according to claim 1, wherein said quasi-cambered element has conical ends which bring about a quasi-cambered shape, said quasi-cambered element has an axial overall length and said conical ends in each case having an axial section length which is at least 10% and at most 30% of said axial overall length.

4. The anilox printing unit according to claim 1, wherein said cambered element forms a convex press strip together with another one of said elements under operating load.

5. The anilox printing unit according to claim 4, wherein one of said cambered element and said quasi-cambered element forms a further convex press strip together with a further one of said elements under operating load.

6. The anilox printing unit according to claim 1, wherein said cambered element or said quasi-cambered element is the only one.

7. The anilox printing unit according to claim 1, wherein said ink applicator roller is said cambered element or said quasi-cambered element.

8. The anilox printing unit according to claim 7, wherein said ink applicator roller has a basic body and a rubber blanket clamped onto said basic body.

9. The anilox printing unit according to claim 8,
further comprising a clamping device for clamping said rubber blanket; and
wherein said basic body has a cylinder channel formed therein, said clamping device disposed in said cylinder channel.

10. The anilox printing unit according to claim 8, wherein said basic body is one of cambered and quasi-cambered.

11. The anilox printing unit according to claim 8, wherein said rubber blanket is one of cambered and quasi-cambered.

12. The anilox printing unit according to claim 8, further comprising an underlay, selected from the group consisting of a cambered underlay and a quasi-cambered underlay, disposed between said basic body and said rubber blanket.

13. The anilox printing unit according to claim 1, wherein said first cylinder is a printing form cylinder and said second cylinder is a blanket cylinder.

14. The anilox printing unit according to claim 1, wherein only one of said elements is selected from the group consisting of said cambered element and said quasi-cambered element.

15. A printing press, comprising:
at least one anilox printing unit containing elements including an engraved roller, an ink applicator roller, a first cylinder, and a second cylinder, at least one of said elements being selected from the group consisting of a cambered element and a quasi-cambered element.
